(19) United States
(12) Patent Application Publication
(10) Pub. No.: US 2009/0255455 A1
(43) Pub. Date: Oct. 15, 2009

(54) TESTING APPARATUS FOR TESTING THE POSITION OF DECORATIVE PIECES

(75) Inventors: ZHENG SHI, Shenzhen City (CN); CHIH-CHIANG CHANG, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/347,142

(22) Filed: Dec. 31, 2008

(30) Foreign Application Priority Data
Apr. 10, 2008 (CN) 200810300973.1

(51) Int. Cl. G09F 9/00

(52) U.S. Cl. 116/306

(57) ABSTRACT

A testing apparatus (100) for testing the position of a decorative piece (36) on a shell (32) includes a seat (10) and a board (20). A receiving space (144) is defined in the seat for receiving the shell. A measuring hole (22) defined in the board. The board is configured for engaging with the seat. The decorative piece is visible through the measuring hole when the board is attached to the seat. A pattern is disposed on the decorative piece. If the pattern is wholly visible through the measuring hole, the annular decorative piece is positioned correctly. If the pattern is not wholly visible through the measuring hole, the annular decorative piece is not positioned correctly.

### BACKGROUND

1. Technical Field

The present invention relates to testing apparatuses, and particularly, to a testing apparatus for testing the position of a decorative piece.

2. Description of Related Art

Decorative pieces are widely applied to electronic devices for improving the appearance of the electronic devices. For example, decorative pieces in the shapes of logos may be attached to a shell of an electronic device. During manufacture, correct positioning of decorative pieces can be difficult to accomplish. Therefore some complex methods have been used to test or check positioning of the decorative piece.

Therefore, there is space for improvement within the art.

### BRIEF DESCRIPTION OF THE DRAWINGS

Many aspects of testing apparatus can be better understood with reference to the following drawings. The components in the drawings are not necessarily drawn to scale, the emphasis instead being placed upon clearly illustrating the principles of the present testing apparatus, in which:

FIG. 1 is an exploded, isometric view of a testing apparatus, in accordance with an exemplary embodiment;

FIG. 2 is an isometric view of a shell of an electronic device, incorporating a decorative piece, in accordance with an exemplary embodiment;

FIG. 3 is an isometric, assembled view of the testing apparatus with the shell shown; and

FIG. 4 is an enlarged view of a circled portion IV of FIG. 3.

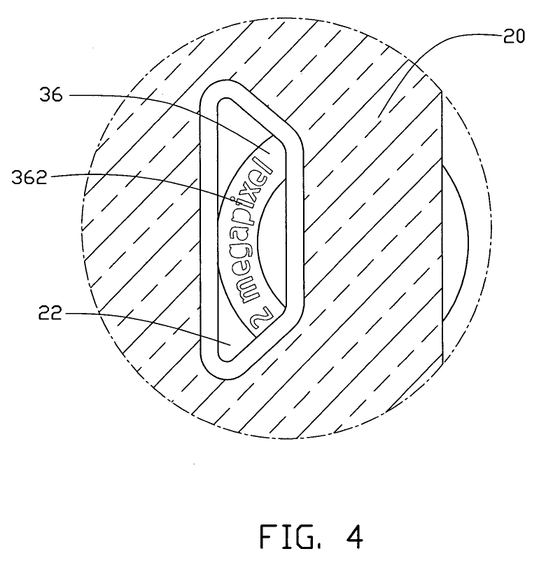

### DETAILED DESCRIPTION OF THE EMBODIMENTS

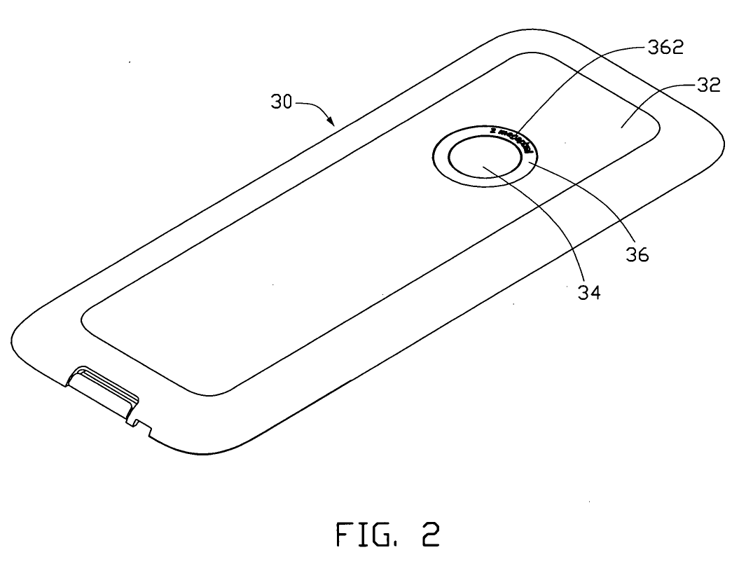

The present testing apparatus is suitable for testing position of a decorative piece on a shell of an electronic device. In this embodiment, an annular decorative piece 36 on a shell 32 shown in FIG. 2 is used as an example to illustrate the present testing apparatus. It is to be understood, however, that the present testing apparatus could be advantageously used in other environments. As such, the present testing apparatus should not be limited in scope by the examples given herein.

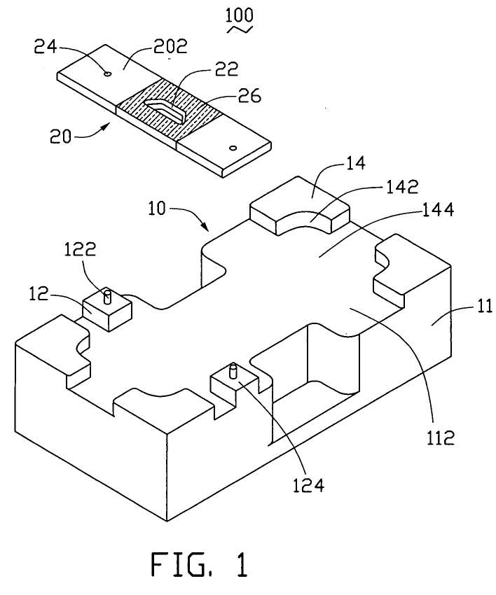

Referring to FIG. 1, a testing apparatus 100 includes a seat 10 and a board 20. The seat 10 has a body portion 11. The body portion 11 may be a flat board or a cube shaped piece, and has a top surface 112. Two protrusions 12 and four blocks 14 are formed on the top surface 112 of the body portion 11. The four blocks 14 are symmetrically disposed at four corners of the body portion 11. Each block 14 has an arcuate sidewall 142 configured to match the shell 32. The sidewalls 142 of the blocks 14 and the top surface 112 of the body portion 11 together form a receiving space 144 for receiving the shell 32 and limit movement of the shell 32. The protrusions 12 are coplanar with the decorative piece 36 on the shell 32 when the shell 32 is set in the seat 10. Each protrusion 12 has an upper surface 124, and two positioning pins 122 respectively formed on the upper surfaces 124 for fixing the board 20.

The board 20 is generally rectangular, and is made of transparent polycarbonate material. Two positioning holes 24 are defined in two ends of the board 20, configured for respectively receiving the two positioning pins 122. A measuring hole 22 is positioned between the two positioning holes 24. The measuring hole 22 is trapezoid shaped. On the upper surface 202, edges along the measuring hole 22 are advantageously rounded or chamfered, and the upper surface 202 is coated with a high contrast material, such as black ink, along and surrounding the measuring hole 22, so that the decorative piece 36 can be clearly seen in the measuring hole 22 during testing, and operators may accurately eyeball position of the decorative piece.

Referring to FIG. 2, the shell 32 of an electronic device (not shown) includes a main body 32 and a camera lens 34 set in the main body 32. The annular decorative piece 36 encircles the camera lens 34 and is attached to the main body 32 by usual means, such as adhesive. A pattern 362 is formed on the annular decorative piece 36; in this embodiment the pattern comprises numbers and letters identifying characteristics associated with the camera (not shown).

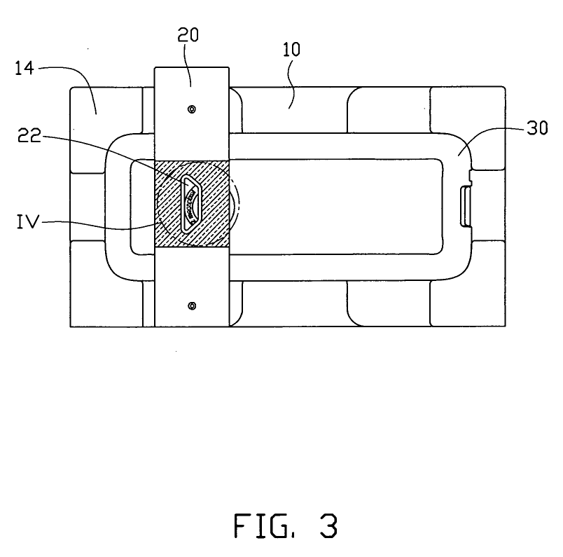

Referring to FIG. 3, in use, the shell 32 with the decorative piece 36 is set in the receiving space 144. The decorative piece 36 is coplanar with the upper surface 124 of the protrusions 12. The board 20 is attached to the seat 10 by engagement of the positioning pins 122 with the positioning holes 24 in the board 20. The pattern 362 on the annular decorative piece 36 is wholly or partly visible through the measuring hole 22. If the pattern 362 is wholly visible through the measuring hole 22, it means that the annular decorative piece 36 is positioned correctly. If the pattern 362 is not wholly visible through the measuring hole 22, it means that the annular decorative piece 36 is not positioned correctly.

It is to be understood that the present testing apparatus may be configured for any shape decorative piece, and the shape of the measuring hole 22 varied accordingly.

It is to be further understood that the protrusions 12 may be omitted, and the positioning pins 122 directly formed on the body portion 11.

It is to be further understood that the blocks 14 of the seat 10 may be joined together or separate, and the number of the blocks 14 may be decided according to need.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A testing apparatus for testing the position of a decorative piece on a shell comprising:
a seat defining a receiving space for receiving the shell; and
a board being configured for engaging with the seat and defining a measuring hole, the decorative piece being visible through the measuring hole when the board is attached to the seat.

2. The testing apparatus as claimed in claim 1, wherein two positioning pins protrude from the seat, two positioning holes are defined in the board, and the positioning holes are configured for respectively engaging with the positioning pins.

3. The testing apparatus as claimed in claim 1, wherein the seat comprises a body portion and at least one block formed on the body portion, the at least one block comprises a sidewall configured for matching with the shell, and a top surface of the body portion and the sidewall of the at least one block together defines the receiving space.

4. The testing apparatus as claimed in claim 1, wherein the board is made of polycarbonate material.

5. The testing apparatus as claimed in claim 1, wherein the measuring hole is trapezoid shaped, and the angles of the trapezoid are determined according to the shape of a pattern on the decorative piece.

6. The testing apparatus as claimed in claim 1, wherein the board is printed with a high contrast material surrounding the measuring hole.

7. The testing apparatus as claimed in claim 1, wherein a pattern is formed on the decorative piece.

8. The testing apparatus as claimed in claim 1, wherein on one surface of the board, edges along the measuring hole are rounded.

9. The testing apparatus as claimed in claim 1, wherein on one surface of the board, edges along the measuring hole are chamfered.

10. The testing apparatus as claimed in claim 1, wherein a pattern is disposed on the decorative piece and the pattern is wholly visible through the measuring hole when the decorative piece is positioned correctly.

11. The testing apparatus as claimed in claim 1, wherein a pattern is disposed on the decorative piece and the pattern is not wholly visible through the measuring hole when the decorative piece is not positioned correctly.
